(19) United States
(12) Patent Application Publication
(10) Pub. No.: US 2008/0099557 A1
(43) Pub. Date: May 1, 2008

(54) Distributed inventory management system

(76) Inventor: Kenneth A. James, Pauma Valley, CA (US)

Correspondence Address: LAW OFFICES OF MORLAND C FISCHER, 2030 MAIN ST, SUITE 1300, IRVINE, CA, 92614, US

(21) Appl. No.: 11/589,438

(22) Filed: Oct. 31, 2006

(51) Int. Cl. G06Q 30/00; G08B 13/14

(52) U.S. Cl. 235/385; 340/572.1

(57) ABSTRACT

Disclosed is a distributed inventory management system in which a self-awareness, self-regulating and self-organizing method is used to compile on a real-time basis ad hoc databases from which the locations of a number of geographically distributed inventory units (e.g., pallets, shipping containers, trailers, railroad cards, trucks, and even people) can be reliably tracked. Each inventory unit in a neighborhood of inventory units carries an electronic tag that includes an alterable memory, a transceiver and a microprocessor. The distance from one inventory unit in the neighborhood to another is dependent upon the received signal strength intensity transmitted between and calculated by the respective transceivers of the electronic tags of different inventory units. The alterable memory of each electronic tag stores first and second databases in which are listed and updated over time the nearest and next nearest neighbors to a particular inventory unit. A dominant inventory unit in the neighborhood establishes a local coordinate system with itself located at the origin thereof, and the other inventory units apply a triangulation algorithm to orient themselves with respect to the local coordinate system. By virtue of the foregoing, the location of the other inventory units relative to the location of the dominant inventory unit can be calculated.

### BACKGROUND OF THE INVENTION

1. Field of the Invention

This invention relates to a distributed inventory management system and to a real-time, self-awareness method for compiling a mobile, ad hoc, geographically distributed database which is indicative of the location of a large number of inventory containers and/or pallets while in transit or during storage. One or more inventory unit electronic tags (each tag including a transceiver, a microprocessor, and an alterable memory) is assigned to each container and/or pallet. The system and method disclosed herein for compiling the geographically distributed database has self-location, self-regulation and self-organization capabilities.

2. Background Art

Whether it be for commercial or government use, inventory management control is becoming particularly relevant as large numbers of goods are shipped to local distribution centers or combat theaters around the world or stored in large indoor and outdoor warehouses or depots. By way of particular example, because its massive logistical operation requires the tactical movement of large volumes of equipment and supplies to troops at geographically remote locations, the Department of Defense (DOD) has explored a variety of automated inventory identification and tracking technologies including bar codes, radio frequency identification (RFID), optical memory cards, satellites, cellular telephone networks, and the like. Such identification and tracking technologies typically communicate departure and arrival times and report to DOD monitors within specified standards.

However, significant gaps exist in the DOD supply chain. First, there is no automated location tracking along the chain. For example, the usual RFID tag is typically a static (i.e., non-self locating) device that must first be queried by an outside communication source before information is available regarding the inventory with which the device is associated. Furthermore, an RFID device is not responsive to changes in conditions or environment (e.g., physical parameters such as temperature and pressure) or elapsed time while awaiting transit from an intermediate shipping point or while in storage at a final destination. In addition, an RFID device is not typically able to generate an alarm condition on its own initiative. Therefore, there is no way for the usual RFID device to signal its arrival and departure automatically. Consequently, shipments may simply stack up and back up upon arrival while awaiting skilled human intervention. Thus, such shipments may appear to be lost or misplaced or simply forgotten which contributes to waste, inefficiency and increased cost to secure and transport replacements.

There are additional places in the information supply chain where information gaps are known to occur. Such gaps may arise when the scanning infrastructure breaks down or where the inventory transfer or staging overwhelms the infrastructure capability. For example, current solutions often depend upon fixed infrastructure to scan the inventory. These solutions may break down when the scanning infrastructure is not available. Current solutions usually rely on their ability to scan inventory in an orderly manner. Such solutions may also break down when the inventory does not enter the fixed infrastructure in an orderly manner. Current solutions rely on their ability to establish communication with the infrastructure. Such solutions are known to break down when distance or other barriers prevent the infrastructure from establishing communication. Current solutions also rely on determining inventory location based upon the location of the infrastructure from which the scanning is performed. These solutions have proven to be inaccurate to locate inventory in a large and densely filled geographic area. Current solutions sometimes require skilled human intervention such as during checking in and checkout out processes. However, it may not be possible to ensure that such human activity is readily available in an efficient, reliable and repeatable fashion.

When any of the foregoing breakdowns occur, degradation of the information supply chain may not be graceful. That is, when gaps occur in the information supply chain, the result can be a complete lack of information as opposed to a gradual degradation of information, especially when the inventory is widespread and geographically remote from the infrastructure. Accordingly, it would be desirable to overcome the shortcomings of conventional inventory management systems and techniques and thereby reduce the needs for a complex infrastructure and the associated process to link the identity of a shipment and its infrastructure such that any degradation in the information supply chain will be graceful so as not result in a complete loss of information.

### SUMMARY OF THE INVENTION

In general terms, a distributed inventory management system is disclosed in which a self-awareness, self-regulating and self-organizing method is used to compute and update on a real-time basis a mobile, ad hoc database in order to reliably track a number of geographically distributed inventory units that travel in a neighborhood of such inventory units. According to the preferred embodiment, the inventory units are one or more shipping containers that are stacked on and travel with a pallet. However, the inventory units herein described may also be trailers, railroad cars, trucks, and the like, and even people which move from place to place within the neighborhood for purposes of transit and storage or during a day's activities.

Each inventory unit (e.g., a shipping container and/or its pallet) has a unique coded identity and carries an electronic tag that is capable of communicating with the electronic tags of the other inventory units in the neighborhood. Each electronic tag includes a source of power, an alterable memory in which information is stored and updated in real time regarding the content and location of the inventory unit as well as the location of other inventory units in the neighborhood, a transceiver to transmit stored information in the alterable memory of the electronic tag to the electronic tags of the other inventory units and receive information therefrom, an antenna by which to enable the transceiver to transmit and receive information, and a microprocessor to control the operation of the alterable memory and the transceiver. The alterable memory, the transceiver and the microprocessor are located below a protective cover of the electronic tag. The antenna is embedded within the protective cover, and pressure and/or temperature sensors may be mounted on the cover to collect information about the environment of the neighborhood in which the inventory unit is located at any time.

The nearest (i.e., one-hop) and the next nearest (i.e., two-hop) inventory unit neighbors of a particular inventory unit is determined according to the attenuation of received signal strength intensity (RSSI) transmitted to the transceiver of the electronic tag of the particular inventory unit from the transceivers of the electronic tags of the other inventory units in the neighborhood. First and second databases listing the nearest and next nearest neighbors and their unique identities are compiled and stored in the alterable memory of the electronic tag of the particular inventory unit. A next nearest (two-hop) inventory unit neighbor is spaced from the particular inventory unit by an RSSI transmission path that runs through one of its nearest (one-hop) neighbors. The first and second databases of the nearest and next nearest neighbors are updated over time depending upon the location of the particular inventory unit relative to the other inventory units in the neighborhood.

Provided that it is designated as a dominant inventory unit within the neighborhood, the electronic tag of the particular inventory unit establishes a local coordinate system having a pair of x- and y-orthogonal axes with the dominant inventory unit located at the origin. The electronic tags of the other inventory units use triangulation to orient themselves with respect to the axes of the local coordinate system so that the location of the inventory units relative to the location of the dominant inventory unit can be computed and stored in the alterable memories of the electronic tags of such other units. As the dominant inventory unit changes its location over time and updates are made to the first and second databases stored therein, new local coordinate systems are established by the dominant inventory unit. The local coordinate systems established by the other inventory units in the neighborhood are rotated so as to coincide with the local coordinate system established by the dominant one of the inventory units.

### BRIEF DESCRIPTION OF THE DRAWINGS

FIG. 1 illustrates inventory unit electronic tags located on shipping containers and a shipping pallet on which the containers are stacked to achieve the distributed inventory management capabilities and advantages according to the present invention;

FIG. 2 is an exploded view showing details of an inventory unit electronic tag of FIG. 1 according to a preferred embodiment;

FIG. 3 is illustrative of an ad hoc database unit network consisting of a neighborhood of inventory unit electronic tags having geometries of one and two hop electronic tag neighbors to form a local coordinate system;

FIG. 4 is a block diagram representing the operational steps that are automatically performed by an ad hoc database unit of FIG. 3 during an active cycle;

FIG. 5 is illustrative of the derivation of a local coordinate system of a particular inventory unit electronic tag within a neighborhood of electronic tags;

FIGS. 6A and 6B illustrate the rotation of one local coordinate system relative to a dominant local coordinate system in response to a rotate instruction; and

FIG. 7 represents three super units providing global positioning to an ad hoc, distributed database.

### DESCRIPTION OF THE PREFERRED EMBODIMENT

FIG. 1 of the drawings is illustrative of a pallet 1 of the type that is used by those in government or within a commercial enterprise to ship inventory from place-to-place or around the world by means of a plane, boat, truck, and the like. Inventory units in the present example are shipped in one or more containers 3 that are stacked upon the pallet 1. In order to track the location of the inventory containers 3 during shipment to an intermediate or final destination and during storage while awaiting deployment, one or a plurality of inventory unit electronic tags 5 are associated with the shipment.

In the illustration of FIG. 1, one or more electronic tags 5 are affixed to and carried with the pallet 1. What is more, one or more additional electronic tags 5 can be affixed to the exterior (as shown) or the interior of some or all of the inventory containers 3. Each inventory unit electronic tag 5 has a variety of information stored therein such as, but not limited to, the contents of the container 3, the original point of shipment, the intended final shipment, an identification number that is unique to the electronic tag, etc.

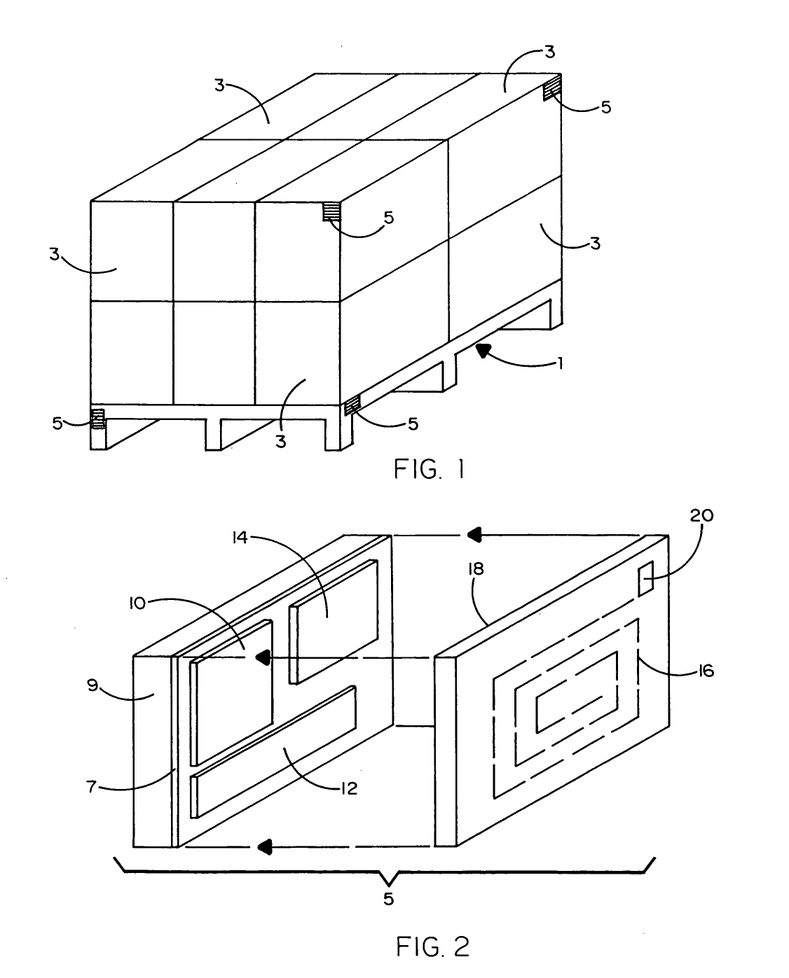

FIG. 2 of the drawings shows details, according to a preferred example, of one of the inventory unit electronic tags 5 to which reference was made in FIG. 1. Such an inventory tag is sometimes known in the communications art as a “mote.” The electronic tag 5 includes a (e.g., plastic) substrate 7. DC power for the electronic tag 5 is preferably provided by means of a 5-volt lithium battery 9 mounted on the bottom of substrate 7. The command and operation of each electronic tag 5 and its ability to communicate and interact with neighboring tags is controlled by a microprocessor 10 that is mounted on the top of substrate 7 opposite the battery 9. A suitable microprocessor 10 for use herein is that manufactured by Atmil and known commercially as AVR.

Also mounted on the top of substrate 7 is an alterable memory 12 in which the tag platform is stored. That is, information concerning the geographic position of the electronic tag relative to a common reference point as well as information concerning the positions of the nearest and second nearest neighbors relative to the position of the electronic tag 5 are stored in a temporary list within the alterable memory 12.

In order to receive transmissions from the neighbors of the electronic tag 5 and to be able to broadcast information concerning the location of tag 5 to its neighbors, a wireless transceiver 14 is mounted on the top of substrate 7. To this end, the transceiver 14 cooperates with a complementary antenna 16 to permit the electronic tags 5 within a neighborhood of geographically distributed tags to communicate (i.e., to receive queries and send replies thereto) with one another. In this regard, and according to a preferred embodiment, each electronic tag 5 herein uses an 802.15 (IEEE standard) communications protocol.

A protective (e.g., plastic) cover 18 is attached (e.g., adhesively bonded or screwed down) over the substrate 7 so that the microprocessor 10, memory 12, and transceiver 14 are sandwiched therebetween. The antenna is typically a thin metal transmission line that is embedded as either a continuous spiral winding 16 or a rectangular patch array (not shown) in the protective cover 18 when the plastic material thereof is melted by a localized source of heat as is common to RFID technology. As an option, the electronic tag 5 may carry one or more (e.g., temperature or pressure) sensors 20 affixed to the protective cover 18. The microprocessor 10 polls the sensor 20 so that physical parameters (e.g., temperature or pressure) may be monitored and corresponding information transmitted which relates to the well being of the contents of the inventory container and the surrounding environment within which the inventory unit electronic tag 5 is located at any particular time.

As previously disclosed, each inventory electronic tag 5 from a neighborhood of tags is capable of identifying its nearest and next nearest neighbors. The distance to the neighbors of any one of the neighborhood of tags is determined by computing in the transceiver 14 the attenuation of the received signal strength intensity (RSSI) transmitted from such neighbors. As will be described in greater detail below, location information is shared among the electronic tags 5 in a neighborhood to produce a set of one-hop (to the nearest neighbor) and two-hop (to the next nearest neighbor) paths that are listed in a pair of ad hoc databases to be stored, altered over time, and restored in the alterable memories 12 of the tags. The nearest one-hop and next nearest two-hop neighbors to any inventory unit in the neighborhood are determined by the actual RSSI transmitted by an electronic tag 5 relative to a predetermined range of RSSIs.

Particular algorithms, to be defined in greater detail hereinafter, use a nearest neighbor count and the RSSI to cause a neighborhood of electronic tags 5 to self-define and select a member tag as a local neighborhood origin with a local horizon. The tags 5 in a neighborhood are then oriented by means of triangulation to the local horizon established by the designated origin tag. All of the origin tags are capable of identifying one another and using the same algorithm to define larger neighborhoods with respective origins and horizons. In other words, all electronic tags of a neighborhood of tags store their nearest and next to nearest neighbor location information, and a small number of the tags also store their status as a neighborhood representative. The neighborhoods expand until all of the tags representing all of the inventory containers or their shipping pallets have been incorporated for the entire inventory to be monitored and managed.

According to one embodiment, a reference origin and horizon are available to the entire inventory in the form of fixed location tags. The hierarchy of neighborhoods will recognize these reference tags, and the entire inventory will, via tag-to-tag information exchange, self-locate according to the reference tags. To accomplish the foregoing, the reference tags must have transmitters that are capable of reaching all tags in the neighborhood. This avoids the need for a tag-to-tag communication to locate the entire inventory.

According to another embodiment of this invention, mobile inventory data and the location of such data are available on an as-needed basis. Querying an unreferenced, distributed database may be tag-to-tag communicated or broadcast to all tags from a server tag, while quantity and location of the queried container is tag-to-tag communicated back to the server. Changes to the contents of a container may be updated by a server tag via tag-to-tag communication or broadcast to the tag via a server tag without broadcast capability. The entire inventory location can be extracted in real time from the mobile, ad hoc distribution of inventory units via tag-to-tag communication.

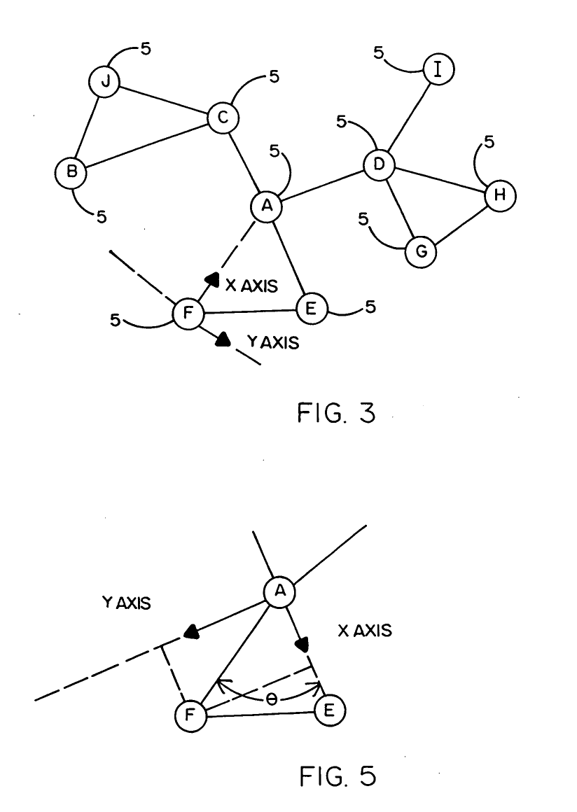

Turning now to FIG. 3 of the drawings, there is shown a representation of an ad hoc database network consisting of a neighborhood of inventory unit electronic tags 5 that are distributed over a geographic area depending upon the real-time locations of the pallets 1 or the inventory containers 3 which carry the electronic tags 5. The spaced distribution of the electronic tags 5 is a random two- or three-dimensional array. For purposes of convenience, a database unit network for a two-dimensional array will be explained while referring to FIG. 3.

Each electronic tag 5 in a neighborhood of tags has a unique identifying number stored therein so as to be capable of identifying itself as well as identifying its nearest and second-nearest electronic tag neighbors. As previously described, the distance from an electronic tag 5 to its nearest neighbors is determined by computing the attenuation of the received signal strength intensity (RSSI) of relatively short range, wireless communication by means of the transceiver and antenna (designated 14 and 16 in FIG. 2). Each electronic tag 5 shares nearest neighbor RSSI information with its nearest neighbors, whereby to produce a table of one-hop and two-hop neighbors within each neighborhood.

### Description of One- and Two-Hop Neighbors

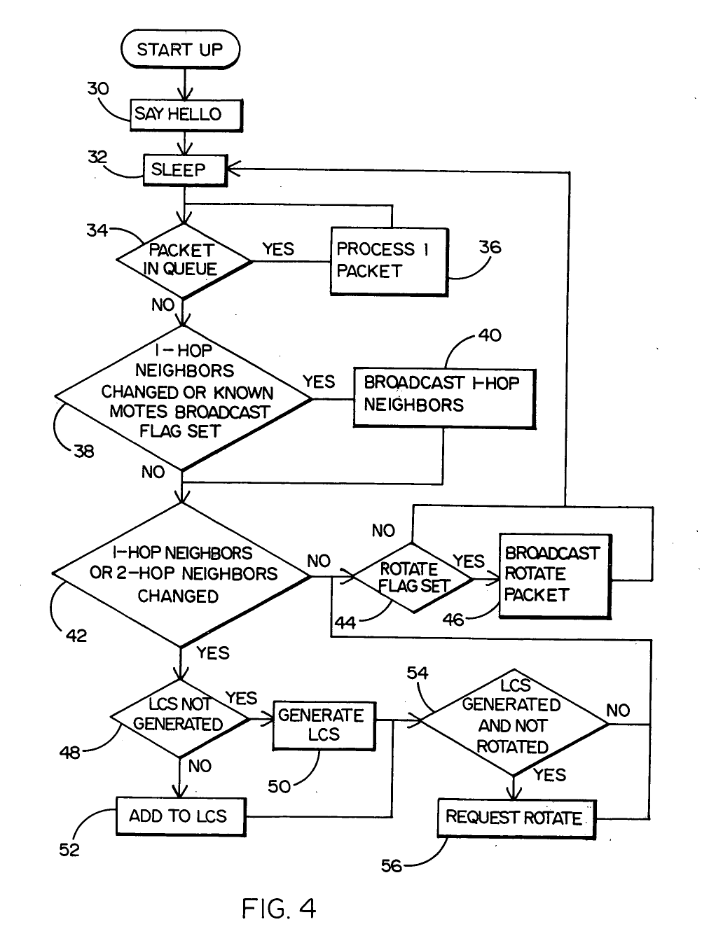

As shown in FIG. 3, unit A (i.e., an inventory unit electronic tag 5 of FIG. 2) has one-hop neighbor units C, D, E and F, while unit C has one-hop neighbor units A, B and J. Thus, units B and J are the two-hop neighbors of unit A through unit C. Units G, H and I are also the two-hop neighbors of unit A through unit D. By definition of a two-hop neighbor, unit A is also a two-hop neighbor of unit F through unit E, and unit E is a two-hop neighbor of unit C through unit A. Each unit A-J identifies its one-hop and two-hop neighbors with RSSI information throughout the entire ad hoc network so that a local coordinate system (LCS) can be established (e.g., with respect to unit F). This neighbor discovery and identification process is described in the flowchart of FIG. 4.

### Overview of Initializing and Upgrading One- and Two-Hop Tables:

Referring in this regard to FIG. 4, the microprocessor of each inventory database unit of FIG. 3 is programmed to collect and store transmitted information in a queue while being inactive (i.e., “asleep”) until it is periodically awakened by an interrupt timer. The first time a database unit “wakes-up”, it broadcasts a “Hello” (step 30) consisting of its unique identification so that the nearest, “one-hop” neighbors can simultaneously detect the unit and its RSSI. If no information has been received from any nearby units and the queue of the broadcasting unit is empty, the unit will go back to its sleep mode (step 32). If information in the form of information packets has been received (step 34), it will be either the identification and RSSI data from one-hop neighbor unit(s) or requests from one-hop neighbor(s). The data is processed one instruction at a time (step 36). This step performs the self-location computational processing illustrated in FIG. 5. After all the packets are processed and the queue is empty (step 34), the database unit will execute a location algorithm that will now be described.

First, the unit will compare its received information with its one-hop neighbor list (step 38) to look for changes in the one-hop neighbors. A one-hop neighbor might have entered the wireless radio range, moved out of the radio range or moved within the radio range. As a step in the self-location of database units in the network, any change of one-hop neighbors requires an update to the database unit location in the ad hoc network. This process is initialized by broadcasting the altered one-hop neighbor table (step 40) with associated RSSI data. While none of the one-hop neighbors of a unit may have moved, a one-hop neighbor's one-hop neighbor (i.e., a two-hop neighbor) of the referenced unit might have moved and that one-hop neighbor now requires a new understanding of its location within the network. That one-hop neighbor will broadcast its new one-hop neighbor table during step 40 to each of its one-hop neighbors forming a “chain-reaction” upgrade by the network location algorithm to the region of the network affected by the change. Exchange of one-hop neighbor information among one-hop neighbors will afford an opportunity to re-evaluate each unit's two-hop neighbor table (step 42).

### Definition of LCS and Rotation:

The terms “LCS” and “rotate” are defined before proceeding further in the description of the database unit operation of FIG. 4. With a set of one- and two-hop neighbors sufficient to triangulate relative locations, each unit assumes itself as an origin and algorithmically selects a line to a nearest neighbor as an “x-axis”. The unit then formulates a “y-axis” orthogonal to the x-axis using another one-hop neighbor to determine the direction of the y-axis. This formulation is illustrated in FIG. 5 of the drawings.

In FIG. 5, unit A has algorithmically selected unit E to form the x-axis of its local coordinate system. Unit A has also algorithmically selected unit F as an intermediate unit from which to form the orthogonal or y-axis with respect to the selected x-axis depending upon the angle θ between the vectors AE and AF. Units A, E, and F then have coordinates in the local coordinate system (LCS) of unit A, as follows:

### Unit A located at (0,0), i.e., the origin.

### Unit E located at (RSSI_{A→E},0), x-coordinate of unit E is the measured RSSI distance from unit A to unit E.

### Unit F located at RSSI_{A→F} cos θ, RSSI_{A→F} sin θ), coordinates of unit F is the measured RSSI distance from unit A to unit F, and θ is determined from the law of cosines

$$θ = {cos}^{- 1} ( \frac{{RSSI}_{A -> F}^{2} + {RSSI}_{A -> E}^{2} - {RSSI}_{E -> F}^{2}}{2 {RSSI}_{A -> E} {RSSI}_{A -> F}} ) ,$$

where RSSI distance from unit E to unit F is known.

In this manner, each database unit, by using its one-hop neighbors and their RSSI data as an indication of relative distance, is capable of locating all of its other one-hop neighbors relative to its own LCS with itself as the origin as shown in FIG. 3. A minimum of three (3) self-aware, one-hop neighbor database units are required for the initiation of this self-location process. As an example, unit F in FIG. 3 will have units A and E as one-hop neighbors and selects a line to unit A as the x-axis for its LCS. The “orthogonal axis”, with y-direction relative to unit E, completes the LCS shown as the perpendicular dashed reference line with respect to the x-axis. All one-hop neighbors to unit F are then located relative to the local coordinate system of unit F by distance and angle. Each self-aware database unit with sufficient one-hop tables forms its own LCS.

Since unit A, which is part of the LCS of unit F has formed an LCS of its own, including unit F, the conflict between the LCS of unit F of FIG. 3 and the LCS of unit A of FIG. 5 must be resolved. Among two or more one-hop neighbors with conflicting LCSs, an algorithm involving nearest-neighbor count, relative RSSI, or unit identification selects one of the LCS of one database unit to have the dominant x-axis line, and that unit issues a “rotate” command to cause its one-hop neighbors to align their LCS with the dominant x-axis. As an example, unit F, having the cleanest RSSI signals (from multiple transmissions) would have its LCS with itself as origin become the dominant origin and its x- and y-axis become the dominant axes. In this case, unit F will send a rotate command to unit A.

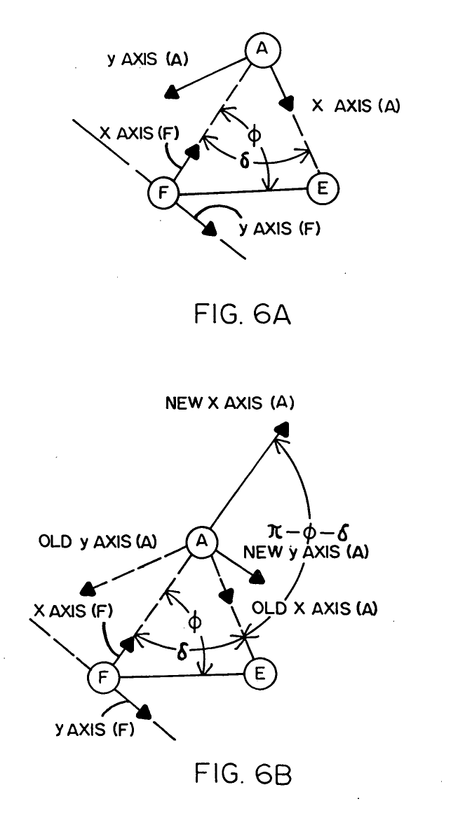

FIGS. 6A and 6B of the drawings show that since units A and F are both one-hop neighbors to unit E, each knows the angle (law of cosines) to unit E in the own local coordinate systems. From the x-axis of unit F, the angle is φ while from the x-axis of unit A, the angle is δ. From simple geometry, the x-axis of unit A must be rotated [180° (π)-φ-δ] from FIG. 6A to FIG. 6B.

Depending upon the orientation of database units used to define an LCS, the relative orientation of the y-axis relative to the x-axis could be rotated by 180° (π), causing the angles φ and δ to be greater than 90° (π/2). The relative size of the angles involved in the rotation process is accounted for by similar analysis to that described when referring to FIGS. 6A and 6B.

As other database units with their individual LCSs, or groups of database units with a common LCS, encounter one another, algorithms involving the number of units presently oriented to a LCS or dominant unit identification will cause colliding database unit “colonies” to rotate and align to the dominant LCS. The ad hoc nature of the formation of a geographically dispersed database precludes the use of synchronized structures so several dominant LCS may develop independently in several unconnected regions of a geographic database as the entire database evolves. The rotation command, relative to the dominant LCS propagates from nearest neighbor to nearest neighbor until the entire database is oriented to the dominant LCS, and all database units are located by distance and angle from the dominant database unit serving as origin. The propagation of the dominant coordinate system is accomplished as will now be explained while referring once again to FIG. 4.

Continuing in this regard from step 42, where a comparison of existing one- and two-hop tables with the most recent data supplied from the one-hop neighbors (which includes the one-hop neighbor data thereof) is performed, if there are no changes in the tables, the database unit checks to see if a rotate command was received (step 44). If a rotate command was received, the unit rotates and passes the message on to its one-hop neighbors (step 46) so they might rotate accordingly. If the existing one- and two-hop tables are different than the received data, the unit checks to see if its LCS was previously generated (step 48). If its LCS was not previously generated and if it has enough information to do so, the unit generates its LCS (step 50). Otherwise, it adds the new database units to its existing LCS (step 52). If a unit has defined its own LCS (step 54) and no other one-hop neighbor has formed its own LCS, then the new one-hop neighbors will be requested to rotate (step 56) to align with the existing LCS by setting a rotate flag (step 44), and sending rotation information (step 46) to its one-hop neighbors.

Since short-range wireless communication causes neighborhoods of database units to be limited in number, networking protocols will use a limited set (as few as a single frequency) of assigned frequencies for self-awareness and self-location for the entire geographically distributed database. Assignment of said frequencies and event-driven communication are protocol driven and part of the self-regulation and self-awareness of the individual database elements.

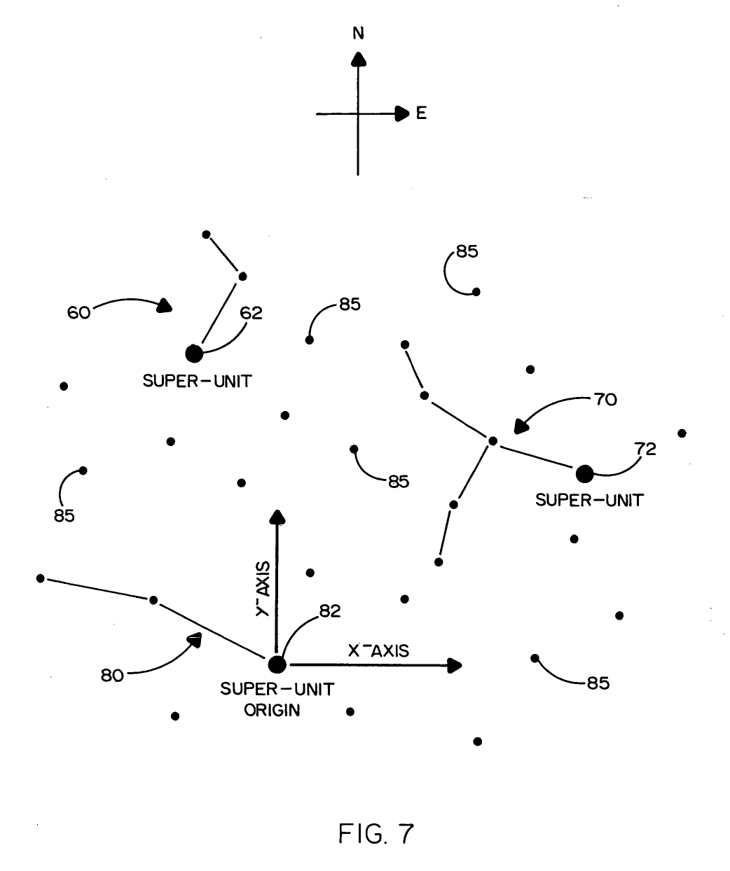

Analysis of the self-locating process algorithm shows that an ad hoc distribution of database units will determine each database position relative to an algorithmically selected dominant unit as origin and the x- and y-axes of the dominant unit. The actual location (orientation and distances) relative to a standard orientation (longitude, latitude, north, south, etc.) is not known. A set of database units with known fixed locations within the general database unit population will allow for global positioning. These located units are “super units” in that they also have the ability to transmit longer distances than regular database units do. At least three super units (not located on a line) are required to bring global positioning to an ad hoc database in the manner shown in FIG. 7. The known distances between super units allow absolute distances to be correlated to RSSI, producing absolute rather than relative distance between units. The known locations of the super database units provide an absolute coordinate system, producing absolute angular orientation of one unit to another. In short, the super units provide an absolute, dominant origin and dominant x- and y-axes for the distributed database.

Super units also can be connected to the internet for purposes of (1) querying the database, (2) reconfiguring the database, and (3) allowing the database to communicate its condition. Since the super units have long distance transmission capability, communication to the database can be accomplished by broadcasting from the super units. Once the absolute location of each regular database unit is known, computer algorithms residing in the super unit system can generate the most energy efficient hop paths from any database unit to a super unit, allowing communication from the database.

Three super unit neighborhoods 60, 70 and 80 including super units 62, 72 and 82 are shown in FIG. 7 which can be used to provide global positioning to an ad hoc distributed database. The super units 62, 72 and 82 are positioned at fixed locations (e.g., at poles) within the general database population of neighborhoods 60, 70 and 80 consisting of a random distribution of data base unit motes 85. One may now remotely (via the internet) query the database through a super unit. The database content information element of interest is hopped back to the super unit which also knows the location of such information. Sample hop paths from the regular database units (i.e., motes 85) to the origins of the super units 62, 72 and 82 are illustrated in FIG. 7

The database may be altered either at the individual unit or by reprogramming the unit's information by a broadcast from the super unit network to the unit of interest. If database units are outfitted with sensors (like that designated 20 in FIG. 2), one or several units can communicate, via hopping, if predetermined levels of sensor information have been reached. These levels can be reprogrammed via broadcast from the super unit network.

Although the preferred embodiment of this invention has been described with respect to tracking the location of geographically distributed inventory containers and/or pallets, it is to be understood that the teachings of this invention are also applicable to tracking other units such as, for example, trailers, railroad cards, trucks, and the like, and even people (e.g., children) that change their location over time.

1. An inventory management system for tracking the location of an inventory unit within a neighborhood of inventory units that are capable of being geographically relocated relative to one another, each inventory unit carrying an inventory unit electronic tag, and each inventory unit electronic tag including a source of power, an alterable memory in which information regarding the content and location of the inventory unit and the location of other inventory units in the neighborhood is stored and updated, a transceiver by which to transmit the information stored in the alterable memory of the electronic tag to the electronic tags of the other inventory units in the neighborhood and to receive information therefrom, and an antenna associated with said transceiver by which the electronic tag of said inventory unit communicates with the respective electronic tags of the said other inventory units in the neighborhood.

2. The inventory management system recited in claim 1, wherein the electronic tag of said inventory unit includes a microprocessor to control the communication of said electronic tag with the respective electronic tags of the other inventory units in the neighborhood.

3. The inventory management system recited in claim 2, wherein each inventory unit electronic tag also includes a substrate, said alterable memory, said transceiver and said microprocessor mounted on said substrate, and a protective cover attached to said substrate so that said alterable memory, said transceiver and said microprocessor are positioned between said substrate and said protective cover.

4. The inventory management system recited in claim 3, wherein the antenna of said inventory unit electronic tag is embedded within said protective cover attached to said substrate.

5. The inventory management system recited in claim 3, wherein said inventory unit electronic tag also includes a temperature sensor mounted on said protective cover, said microprocessor communicating with said temperature sensor to receive temperature information concerning the environment in which said inventory unit is located.

6. The inventory management system recited in claim 3, wherein said inventory unit electronic tag also includes a pressure sensor mounted on said protective cover, said microprocessor communicating with said pressure sensor to receive pressure information concerning the environment within which said inventory unit is located.

7. The inventory management system recited in claim 2, wherein said inventory unit electronic tag is responsive to the attenuation of the received signal strength intensity (RSSI) transmitted by the respective transceivers of the electronic tags of other inventory units in the neighborhood of inventory units as an indication of the distance between said inventory unit and its neighbors.

8. The inventory management system recited in claim 7, wherein each of said inventory units in the neighborhood of inventory units has a unique coded identity that is transmitted by the respective transceivers of said inventory unit electronic tags to one another.

9. The inventory management system recited in claim 8, wherein the alterable memory of said inventory unit electronic tag stores a list of the nearest and next nearest inventory unit neighbors to said inventory unit depending upon the RSSIs received from its neighbors and the distances corresponding thereto.

10. The inventory management system recited in claim 9, wherein the distance between said inventory unit and one of its next nearest inventory unit neighbors includes an RSSI transmission path that runs through one of the nearest inventory unit neighbors.

11. The inventory management system recited in claim 9, wherein the list of the nearest and next nearest inventory unit neighbors that is stored in the alterable memory of said inventory unit electronic tag changes over time depending upon the locations of said inventory unit and its neighbors within the neighborhood of the inventory units.

12. The inventory management system recited in claim 1, wherein the electronic tag of a particular one of said inventory units in the neighborhood of inventory units establishes a local coordinate system having at least a pair of orthogonal coordinate axes with said particular inventory unit located at the origin, each of the electronic tags of the other inventory units in the neighborhood using triangulation to orient itself with respect to the coordinate axes of said local coordinate system so that the locations of said other inventory units relative to the location of said particular inventory unit are computed and stored in the alterable memories of the electronic tags of said particular inventory unit and said other inventory units.

13. The inventory management system recited in claim 12, wherein the particular one of said inventory units in the neighborhood of inventory units that is designated as the origin inventory unit is disposed at a fixed location within said neighborhood.

14. A method for tracking the location of the particular inventory unit in the neighborhood of inventory units as recited in claim 12, said method comprising the steps of:
measuring by means of the transceiver of the electronic tag of said particular inventory unit the attenuation of the RSSI transmitted from each of the other inventory units in the neighborhood;
storing within the alterable memory of the electronic tag of said particular inventory unit a first database containing the distances of the nearest inventory unit neighbors to said particular inventory unit depending upon the RSSIs received therefrom;
including within said first database the respective coded identities of said nearest inventory unit neighbors; and
updating said first database over time as said particular inventory unit and/or its inventory unit neighbors move relative to one another.

15. The method for tracking recited in claim 14, comprising the additional step of said particular inventory unit broadcasting said first database and said updates thereto to each of its nearest inventory unit neighbors in said neighborhood of inventory units.

16. The method for tracking recited in claim 15, including the additional steps of also storing within the alterable memory of the electronic tag of said particular inventory unit a second database of the distances of the second nearest inventory unit neighbors to said particular inventory unit depending upon the RSSIs received therefrom via an RSSI transmission path that runs through one of the nearest inventory unit neighbors;
including within said second database the respective coded identities of said second nearest inventory unit neighbors; and
updating said second database over time as said particular inventory unit and/or its inventory unit neighbors move relative to one another.

17. The method for tracking recited in claim 16, comprising the additional step of the electronic tag of said particular inventory unit establishing a new local coordinate system depending upon the contents of said first and second databases following the updates thereto.

18. The method for tracking recited in claim 14, comprising the additional steps of the electronic tag of said particular inventory unit algorithmically establishing a local coordinate system having orthogonal x- and y-axes with said particular inventory unit located at the origin of said coordinate system;
designating said x-axis extending from said particular inventory unit and running through one of the nearest inventory unit neighbors to said particular inventory unit; and
designating said y-axis extending from said particular inventory unit and aligned orthogonally with said x-axis.

19. The method for tracking recited in claim 18, comprising the additional step of trigonometrically computing the angle between the x-axis of said local coordinate system and a vector extending from said particular inventory unit and running through another one of the nearest inventory unit neighbors to said particular inventory unit, whereby to obtain an indication of the location of said other nearest inventory unit neighbor relative to the particular inventory unit located at the origin of said local coordinate system, the RSSIs transmitted by the one and the other of said nearest inventory unit neighbors providing indications of the distance between said other inventory unit neighbor and said particular inventory unit and the distance between said other nearest inventory unit neighbor and said one nearest inventory unit neighbor.

20. The method for tracking recited in claim 18, comprising the additional step of rotating the local coordinate system established by the electronic tag of said particular inventory unit such that the x- and y-axes of said local coordinate system are aligned with the x- and y-axes of the local coordinate system of an inventory unit neighbor to said particular inventory unit.
